(19) United States
(12) Patent Application Publication
(10) Pub. No.: US 2008/0096434 A1
(43) Pub. Date: Apr. 24, 2008

(54) Microphone Connector

(75) Inventors: Hsin-Tsung Ho, Taipei Hsien (TW); Chung-Hsin Huang, Taipei Hsien (TW); Mei-Chuan Yang, Tu-Cheng City (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 11/550,592

(22) Filed: Oct. 18, 2006

(51) Int. Cl. H01R 24/00

(52) U.S. Cl. 439/660

(57) ABSTRACT

A microphone connector includes an insulation housing and an electrical contact. The insulation housing has an insertion passage arranged at a top surface thereon, a receiving space arranged at a bottom surface thereon and communicated with the insertion passage and grooves passing through opposite sidewalls of the insulation housing. The electrical contact includes a body portion arranged up on the sidewalls, a soldering portion arranged at one end of the body portion, at least two opposite arms arranged at the other end of the body portion and received in the corresponding grooves respectively and elastic connection portions respectively arranged at the side arms and received in the receiving space. While a terminal of a microphone inserts into the insertion passage and electronically couples to the elastic connection portions to form multi-conductive areas, signal is transmitted between the microphone and the microphone connector stably through the multi-conductive areas.

### BACKGROUND OF THE INVENTION

1. Field of the Invention

The invention relates to a microphone connector, and particularly to a microphone connector capable of transmitting signal stably.

2. The Related Art

According to the current development of electrical technology, portable electrical devices such as mobile phones, personal digital assistants, and others, are capable of communicating with other electrical devices through electrical connectors configured therein. Because of downsizing issue and reducing weight, size of the portable electrical devices is getting smaller. Consequently, downsizing size issue is also a designing purpose of the electrical connectors.

A microphone connector is disclosed in Taiwan Patent Application No. 087218667. The microphone connector is arranged at a surface of a printed circuit board. The microphone connector includes a housing, a receiving room leaded to a top surface and a bottom surface of the housing, a cyclic projection arranged at the bottom surface of the housing and surrounded the receiving room. An E-shape electrical contact has two fixed portions and a connection portion between the fixed portions. A soldering portion is arranged at a free end of the fixed portion and perpendicular to the fixed portion for soldering to the printed circuit board. While the housing and the E-shape electrical contact are assembled, the fixed portions of the E-shape electrical contact respectively contact both sides of the housing and the connection portion of the E-shape electrical contact is received in the receiving room of the housing.

While the microphone connector engages with a microphone, connection portion of the E-shape electrical contact electrical couples to a terminal of the microphone to form single conductive point for transmitting signal therebetween. Therefore, the signal is transmitted between the microphone and the microphone connector only through the single conductive point between the terminal of the microphone and the connection portion of the microphone connector. However, if the single conductive point between the microphone and the microphone connector would not be set up, for example the connection portion departing from the microphone connector, the connection portion broken up and so on, the signal transmitting between the microphone and the microphone connector is incorrectly

### SUMMARY OF THE INVENTION

An object of the present invention is to provide a microphone connector having multi-conductive areas formed between the microphone connector and a microphone capable of transmitting signal stably through the multi-conductive areas.

According to the invention, the microphone connector includes an insulation housing and an electrical contact. The insulation housing has an insertion passage formed on a top surface thereon, a receiving space arranged at a bottom surface thereon and communicating to the insertion passage and grooves passing through opposite sidewalls of the insulation housing. The electrical contact includes a body portion arranged up on one of the sidewalls of the insulation housing, a soldering portion arranged at one end of the body portion, at least two opposite arms arranged at the other end of the body portion and received in the corresponding grooves of the insulation housing respectively and elastic connection portions respectively arranged at the opposite arms and received in the receiving space of the insulation housing.

While the microphone connector engages with the microphone, a terminal of the microphone inserts into the insertion passage of the insulation housing and electronically couples to the elastic connection portions of the electrical contact to form multi-conductive areas between the terminal of the microphone and the elastic connection portions of the electrical contact. Therefore, the signal is transmitted between the microphone and the microphone connector stably through the multi-conductive areas between the terminal of the microphone and the elastic connection portions of the electrical contact of the microphone connector.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a first embodiment of a microphone connector according to the present invention;

FIG. 2 is an exploded view showing a front side of the first embodiment of the microphone connector;

FIG. 3 is an exploded view showing a rear side of the first embodiment of the microphone connector;

FIG. 4 is a perspective view showing an electrical contact of the first embodiment of the microphone connector;

FIG. 5 is a perspective view showing a microphone engaged with the microphone connector;

FIG. 6 is a cross-sectional view showing the microphone engaged with the microphone connector along line VI-VI.

FIG. 7 is a perspective view of a second embodiment of a microphone connector according to the present invention;

FIG. 8 is an exploded view showing a front side of the second embodiment of the microphone connector;

FIG. 9 is an exploded view showing a rear side of the second embodiment of the microphone connector;

FIG. 10 is a perspective view showing a first electrical contact and a second electrical contact of the second embodiment of the microphone connector;

FIG. 11 is a perspective view showing the microphone engaged with the microphone connector;

FIG. 12 is a cross-sectional view showing the microphone engaged with the microphone connector along line XII-XII.

### DETAILED DESCRIPTION OF THE PREFERRED EMBODIMENT

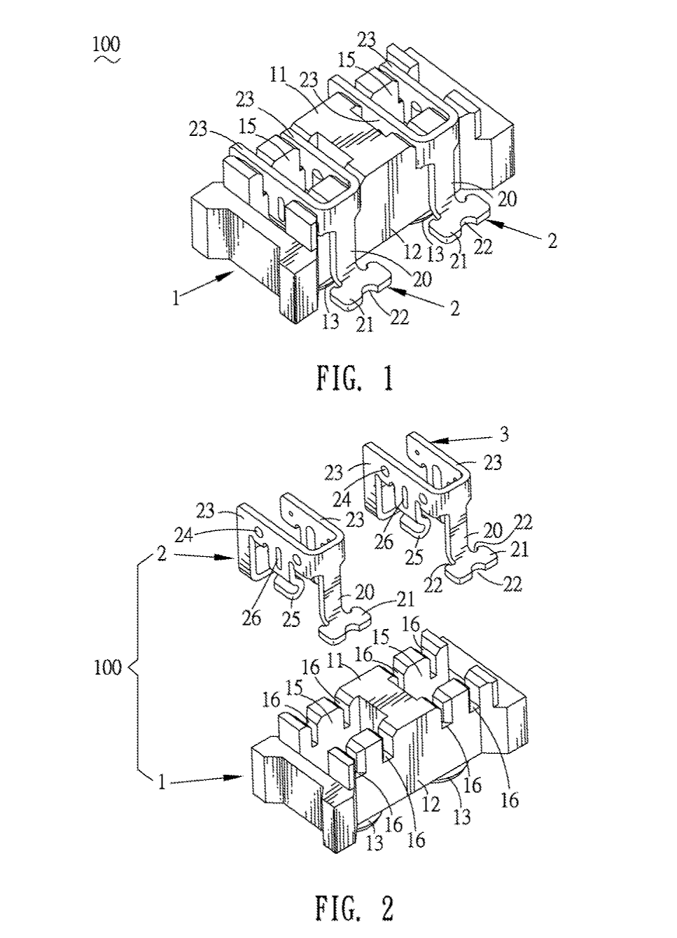

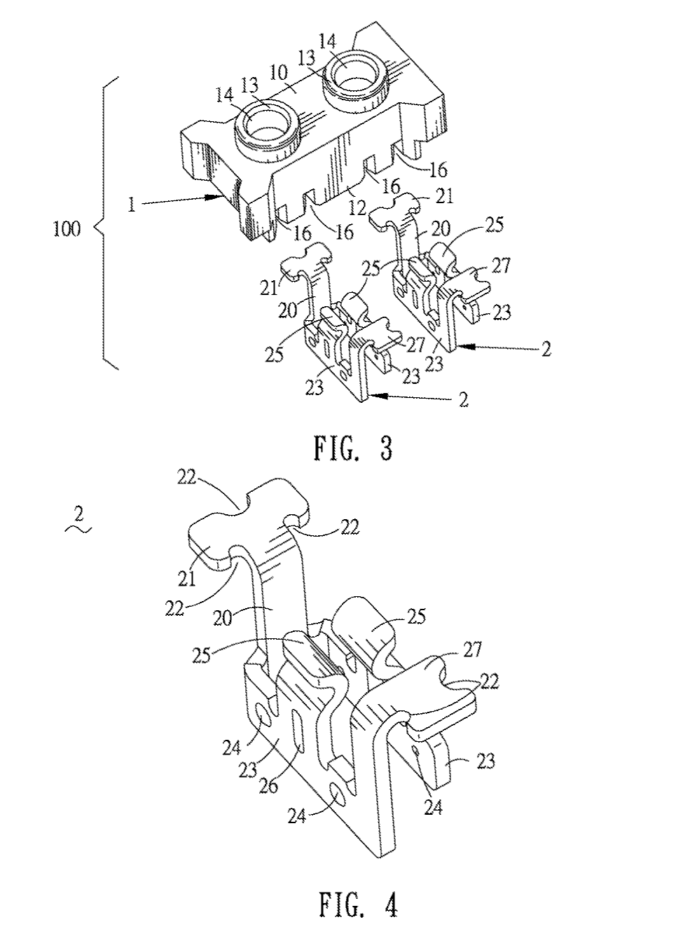

Please refer to FIG. 1 to FIG. 3, which shows a first preferred embodiment of a microphone connector 100 according to the present invention. The microphone connector 100 disposes on a printed circuit board (not shown in figures) and engages with a microphone 5 (shown in FIG. 5). The microphone connector 100 has an insulation housing 1 and an electrical contact 2.

The insulation housing 1 has a top surface 10, a bottom surface 11 opposite to the top surface 10 and at least two opposite sidewalls 12 respectively connecting the top surface 10 and the bottom surface 11. A cyclic projection 13 is mounted on the top surface 10 of the insulation housing 1. Further, the printed circuit board has a through hole (not shown in figures) for receiving the cyclic projection 13 of the insulation housing 1.

An insertion passage 14 is received in the insulation housing 1 and perpendicular to the top surface 10 of the insulation 1. One end of the insertion passage 14 is opened on a central area of the cyclic projection 13. A receiving space 15 is also received in the insulation housing 1 and perpendicular to the bottom surface 11 of the insulation housing 1. One end of the received space 15 is opened on the bottom surface 11 of the insulation 1. The other end of the receiving space 15 partially communicates the other end of the insertion passage 14. Plurality of grooves 16 are arranged to through the sidewalls 12 and communicated the receiving space 15 respectively.

Referring to FIG. 1 to FIG. 4, the electrical contact 2 has a body portion 20 arranged up on one of the sidewalls 12 and parallel to the sidewalls 12 of the insulation housing 1. One end of the body portion 20 is extended and curved to form a first soldering portion 21, which is parallel to the top surface 10 of the insulation housing 1 and soldered to the printed circuit board. At least one indentation 22 is arranged at edges of the first soldering portion 21 for engaging with soldering tin on the printed circuit board quickly, especially through surface mount technology. Therefore, the first soldering portion 21 of the electrical contact 2 is soldered to the printed circuit board quickly due to the indentation 22 of the electrical contact 2 quickly engaging with the soldering tin on the printed circuit board.

At least two opposite arms 23, which are perpendicular to the body portion 20 and received in the corresponding grooves 16 of the insulation housing 1, are extended and curved from opposite sides of the other end of the body portion 20 respectively. At least two projections 24 corresponding to the grooves 16 of the insulation housing are mounted on the each side arm 23 of the electrical contact 2. While the electrical contact 2 and the insulation housing 1 are assembled, the opposite arms 23 are received in the corresponding grooves 16 of the insulation 1 respectively and the projections 24 of the electrical contact 2 are rubbed on inner surface of the grooves 16 respectively. Therefore, the electrical contact 2 engages with the insulation housing 1 due to the projection 24 of the electrical contact 2 rubbed on the inner surface of the grooves 16 of the insulation housing 1.

Still Referring to FIG. 1 to FIG. 4, At least two elastic connection portions 25 are arranged at a central area of one edge of the opposite arms 23 respectively and received in the receiving space 15 of the insulation 1. In this case, the elastic connection portions 25 are curved and formed an arc-shape and projecting each other. Ribs 26 are arranged between the opposite arms 23 and the elastic connection portions 25 respectively and projecting each other. While the microphone connector 100 engages with the microphone 5 and a terminal 50 of the microphone 5 pushes the elastic connection portions 25 of the electrical contact 2, the ribs 26 strengthen the connection between the elastic connection portions 25 and the opposite arms 23.

A second soldering portion 27 is extended from a free end of one of the arms 23 and curved toward the other arm 23 for soldering to the printed circuit board. The second soldering portion 27 is also parallel to the top surface 10 of the insulation housing 1. The second soldering portion 27 also has the indentations 22 arranged at its edges for engaging with the soldering tin on the printed circuit board. Consequently, the second soldering portion 27 of the electrical contact 2 is soldered to the printed circuit board quickly due to the indentation 22 of the electrical contact 2 quickly engaging with the soldering tin on the printed circuit board.

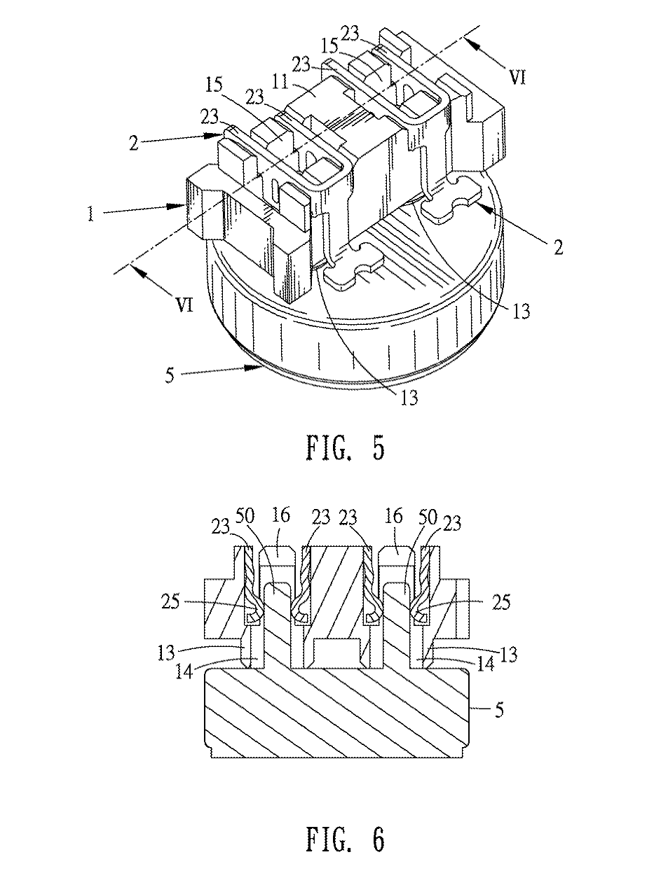

Please refer to FIG. 5 and FIG. 6. While the microphone connector 100 engages with the microphone 5, the terminal 50 of the microphone 5 inserts into the insertion passage 14 of the insulation housing 1. The terminal 50 of the microphone 5 pushes the elastic connection portions 25 of the electrical contact 2 and electronically couples to the elastic connection portions 25 to form multi-conductive areas between the terminal 50 of the microphone 5 and the elastic connection portions 25 of the electrical contact 2 of the microphone connector 100. Therefore, signal is transmitted between the microphone connector 100 and the microphone 5 stably through the multi-conductive areas.

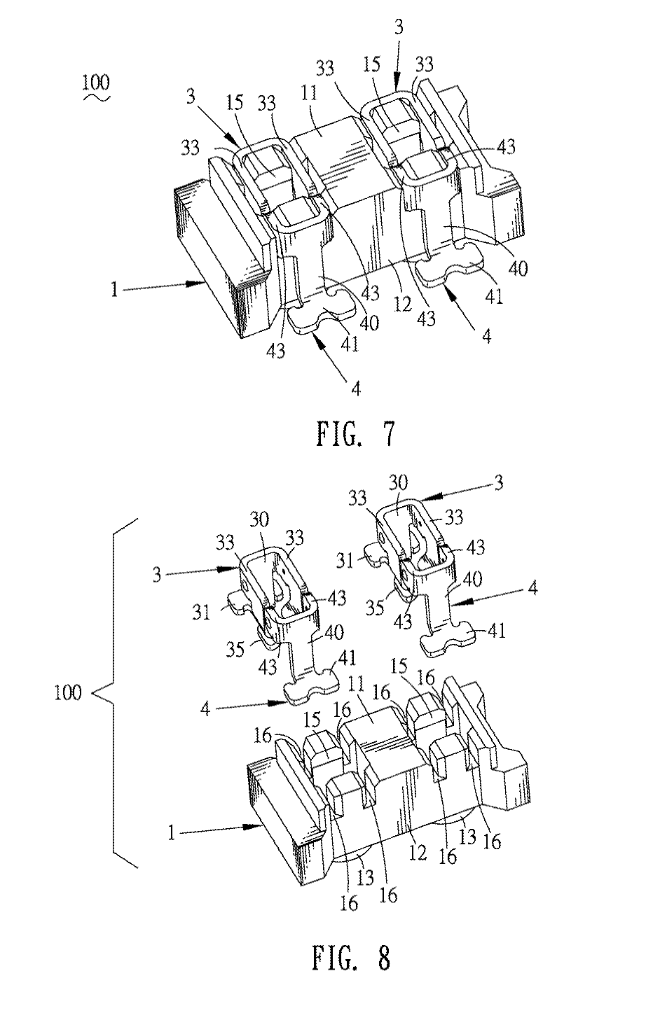

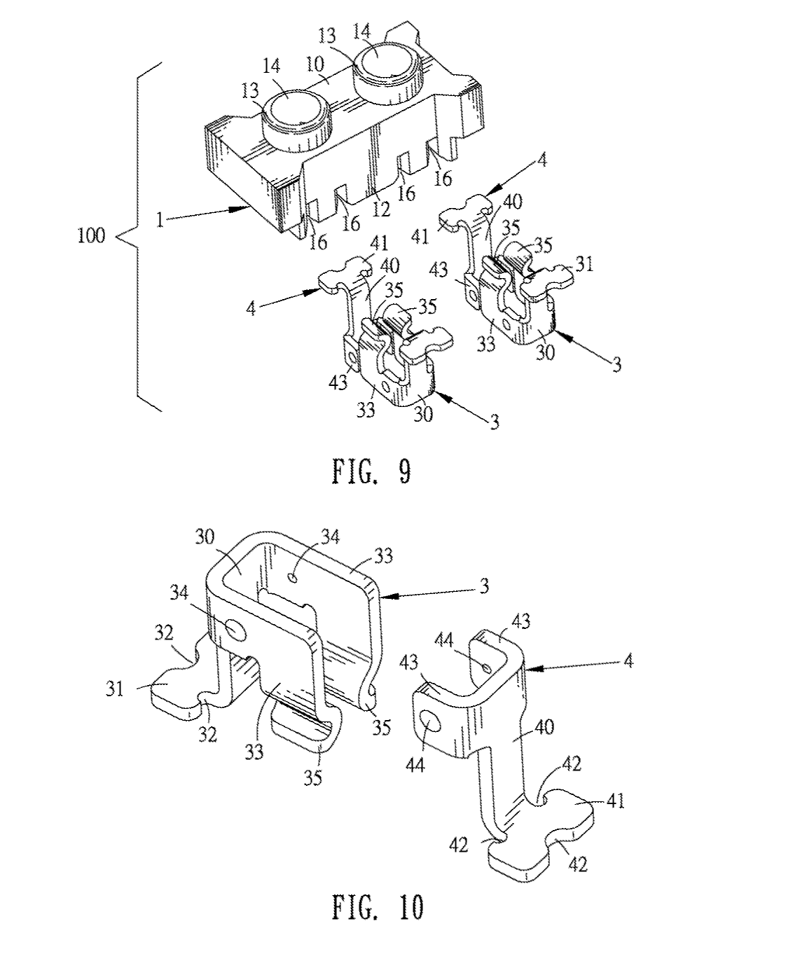

Referring to FIG. 7 to FIG. 10, which shows a second preferred embodiment of a microphone connector 100 according to the present invention. The electrical contact 2 is substituted for a first electrical contact 3 and a second electrical contact 4 arranged opposite to the first electrical contact 3. The first electrical contact 3 and the second electrical contact 4 have a first body portion 30 and a second body portion 40 respectively. The first body portion 30 of the first electrical contact 3 is parallel to the sidewalls 12 and arranged up on one of the sidewalls 12. The second body portion 40 of the second electrical contact 4 is also parallel to the sidewalls and arranged up on the other sidewall 12.

One end of the first body portion 30 and one end of the second body portion 40 are extended and curved to form a third soldering portion 31 and a fourth soldering portion 41 respectively for soldering to the printed circuit board. The third soldering portion 31 and the fourth soldering portion 41 are parallel to the top surface 10 of the insulation housing 1. The third soldering portion 31 and the fourth soldering portion 41 respectively have indentations 32, 42 arranged at edges of the third soldering portion 31 and edges of the fourth soldering portion 41 for engaging with the soldering tin on the printed circuit board quickly. According to the indentations 32, 42 engage with the soldering tin on the printed circuit board quickly, the third and fourth soldering portions 31, 41 are soldered to the printed circuit board quickly, especially through surface mount technology.

At least two opposite first arms 33 and opposite second arms 43, which are perpendicular to the first body portion 30 and the second body portion 40 respectively and received in the corresponding grooves 16 at the different sidewalls 12 of the insulation housing 1, are extended and curved from opposite sides of the other end of the first body portion 30 and opposite sides of the other end of the second body portion 40 respectively. Each the first arms 33 and the second arms 43 respectively have at least one first projection 34 and second projection 44 respectively corresponding to the grooves 16 arranged at different sidewalls 12 of the insulation housing 1.

While the first electrical contact 3, the second electrical contact 4 and the insulation housing are 1 assembled, the first arms 33 and the second arms 43 are received in the corresponding grooves 16 at different sidewalls 12 of the insulation housing 1 respectively and the first projection 34 and the second projection 44 are rubbed on inner surface of the corresponding grooves 16 respectively. Therefore, the first electrical contact 3 and the second electrical contact 4 engage with the insulation housing 1 due to the first projection 34 and the second projection 44 rubbed on the inner surface of the corresponding grooves 16 of the insulation housing 1.

Still referring to FIG. 7 to FIG. 10, the first electrical contact 3 further has at least two first elastic connection portions 35. In this case, the first elastic connection portions 35 are arranged at one side of the other end of the opposite first arms 33 respectively. The first elastic connection portions 35 are perpendicular to the arms 33 and receiving in the receiving space 15 of the insulation 1. In this case, the first elastic connection portions 35 are curved and formed an arc-shape and projecting each other.

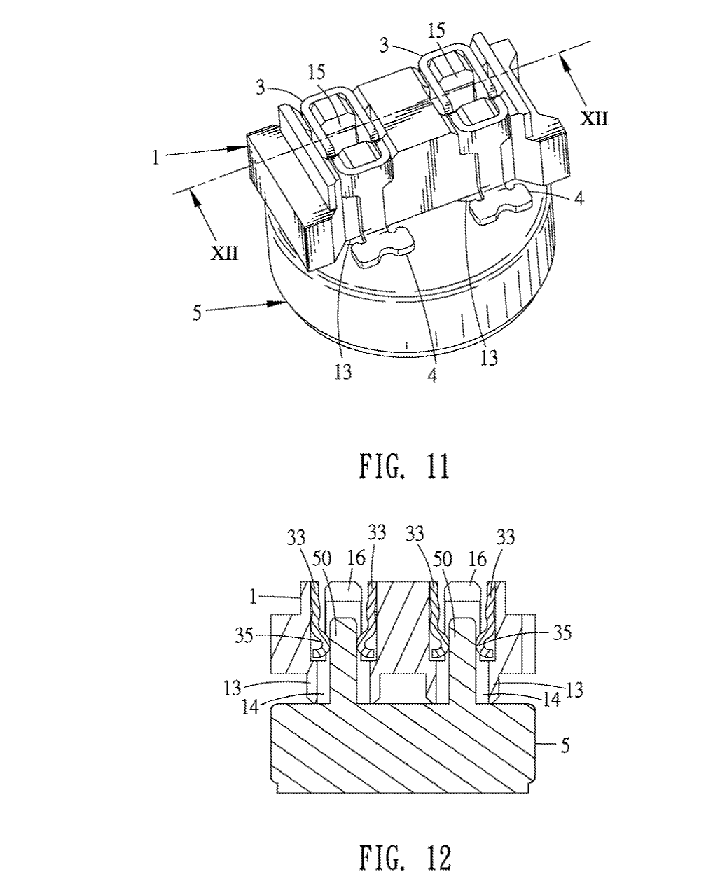

Please refer to FIG. 11 and FIG. 12. While the microphone connector 100 engages with the microphone 5, the terminal 50 of the microphone 5 inserts into the insertion passage 14 of the insulation housing 1. The terminal 50 of the microphone 5 pushes the first elastic connection portions 35 of the first elastic electrical contact 3 and electronically couples to the first elastic connection portions 35 to form multi-conductive areas. Therefore, the signal is transmitted between the microphone connector 100 and the microphone 5 stably through the multi-conductive areas.

Furthermore, the present invention is not limited to the embodiments described above; various additions, alterations and the like may be made within the scope of the present invention by a person skilled in the art. For example, respective embodiments may be appropriately combined.

What is claimed is:

1. A microphone connector disposed on a printed circuit board, comprising:
an insulation housing having a top surface, a bottom surface opposite to said top surface, two opposite sidewalls respectively connected to said top surface and said bottom surface, a cyclic projection arranged on said top surface, an insertion passage formed in a central area of said cyclic projection and perpendicular to said top surface, a receiving space formed on said bottom surface and perpendicular to said bottom surface, said receiving space partially communicated with said insertion passage and grooves passing through said sidewalls and communicated with said receiving space; and
an electrical contact having a body portion parallel to said sidewalls, a first soldering portion curved from one end of said body portion for soldering to said printed circuit board, at least two opposite arms arranged at opposite sides of the other end of said body portion, which perpendicular to said body portion and received in said grooves of said insulation housing, at least two elastic connection portions arranged at said opposite arms respectively and received in said receiving space of said insulation housing.

2. The microphone connector as claimed in claim 1, wherein said first soldering portion is parallel to said top surface of said insulation housing.

3. The microphone connector as claimed in claim 1, further comprising at least one indentation formed on edges of said first soldering portion of said electrical contact.

4. The microphone connector as claimed in claim 1, further comprising projections mounted on said opposite arms of said electrical contact respectively and corresponding to said grooves of said insulation housing.

5. The microphone connector as claimed in claim 1, wherein said elastic connection portions are arranged at a central area of one edge of said opposite arms, which are curved and formed an arc-shape and projecting each other.

6. The microphone connector as claimed in claim 1, further comprising ribs mounted between said opposite arms and said elastic connection portions respectively and projecting each other.

7. The microphone connector as claimed in claim 1, further comprising a second soldering portion arranged at free end of one of said opposite arms for soldering to said printed circuit board.

8. The microphone connector as claimed in claim 7, wherein said second soldering portion is curved toward said the other arm.

9. The micro phone connector as claimed in claim 7, further comprising at least one indentation formed on edges of said second soldering portion of said electrical contact.

10. A microphone connector disposed on a printed circuit board, comprising:
an insulation housing having a top surface, a bottom surface opposite to said top surface, two opposite sidewalls respectively connected to said top surface and said bottom surface, a cyclic projection arranged on said top surface, a insertion passage formed in a central area of said cyclic projection and perpendicular to said top surface, a receiving space formed on said bottom surface and perpendicular to said bottom surface, said receiving space partially communicated with said insertion passage and grooves passing through said sidewalls and communicated with said receiving space;
a first electrical contact having a first body portion parallel to said sidewalls and arranged up on one of said sidewalls, a third soldering portion curved from one end of said first body portion for soldering to said printed circuit board, at least two opposite first arms arranged at opposite sides of the other end of said first body portion, which perpendicular to said first body portion and respectively received in said grooves arranged at one of said sidewalls of said insulation housing, at least two first elastic connection portions arranged at said opposite first arms respectively and received in said receiving space of said insulation; and
a second electrical contact arranged opposite to said first electrical contact, which having a second body portion parallel to said sidewalls of said insulation housing and arranged up on the other said sidewall, a fourth soldering portion curved from one end of said second body portion for soldering to said printed circuit board, at least two opposite second arms arranged at opposite sides of the other end of said second body portion, which perpendicular to said second body portion and respectively received in said grooves arranged at said the other sidewall of said insulation housing.

11. The microphone connector as claimed in claim 10, wherein said third soldering portion and said fourth soldering portion are parallel to said top surface of said insulation housing respectively.

12. The microphone connector as claimed in claim 10, further comprising at least one indentation formed on edges of said third soldering portion and edges of said fourth soldering portion respectively.

13. The microphone connector as claimed in claim 10, further comprising projections mounted on said opposite first arms of said first electrical contact and opposite second arms of said second electrical contact respectively and corresponding to said grooves of said insulation housing.

14. The microphone connector as claimed in claim 10, wherein said first elastic connection portions are curved and formed an arc-shape and projecting each other.
